(19) United States
(12) Patent Application Publication
(10) Pub. No.: US 2007/0258784 A1
(43) Pub. Date: Nov. 8, 2007

(54) AIR CARGO CONTAINER EXTENSION UNIT

(76) Inventor: Robert Looker, El Segundo, CA (US)

Correspondence Address: PERKINS COIE LLP, POST OFFICE BOX 1208, SEATTLE, WA, 98111-1208, US

(21) Appl. No.: 11/381,273

(22) Filed: May 2, 2006

(51) Int. Cl. B60P 1/64

(52) U.S. Cl. 410/52

(57) ABSTRACT

A cargo container assembly includes a main container and an extension container which can be attached to an upper portion of the main container. The extension container may be attached to the main container via a locking mechanism attached to or integral with the main container or the extension container. During ground shipping, the extension container and the main container may be separated from each other so that they may stay within ground transport height limitations. An optional transportation pallet, onto which one or more extension containers may be stacked and secured, may be included for ground transportation. During air shipping, an extension container and a main container may be attached to each other to maximize use of the available cargo space in an aircraft.

### BACKGROUND

Standard Boeing 747 cargo aircraft are configured to accommodate several air cargo containers up to approximately 120 inches in height. Bridge height limitations on highways, however, generally prevent cargo containers having heights greater than approximately 96 inches from being trucked to and from locations. As a result, the air cargo industry typically uses air cargo containers having a height of approximately 96 inches to transport cargo, leaving approximately 24 inches of unused vertical space available inside a standard Boeing 747 cargo aircraft. The United Parcel Service (“UPS”), for example, uses standard “M1” shipping containers, which are approximately 96 inches high by 96 inches wide by 125 inches long, to transport air cargo. A standard M1 container typically includes a curved or chamfered rear upper section that substantially conforms to the curvature of the fuselage of an aircraft. Each M1 container provides approximately 593 cubic feet of available storage space for cargo.

An M1 container used to ship air cargo typically carries an average load of approximately 8900 pounds. Standard M1 containers, however, are certified to transport up to 15,000 pounds of cargo. Thus, it would be advantageous to modify a standard M1 container, or a similar container, so that it occupies more available cargo space in an aircraft, while still being efficiently transportable along highways.

### SUMMARY

The extension container is removably attachable to a main cargo shipping container, such as a standard M1 container or other container, to form a modified cargo container assembly. Attachment elements attach the extension container to the main container. The modified cargo container assembly allows more cargo to be carried in an aircraft.

For ground shipping, the extension container and the main container can be detached from each other and shipped as separate units that each meet bridge or other height limitations. An optional transportation pallet, onto which one or more extension containers may be stacked and secured, may be included for ground transportation. For air shipping, the extension container can be attached to the main container to form a container assembly that occupies more of the available storage space in an aircraft.

Other features and advantages of the invention will appear hereinafter. The features of the invention described above can be used separately or together, or in various combinations of one or more of them. The invention resides as well in sub-combinations of the features described. Furthermore, many of the method steps described herein may be performed in a different order than that which is explicitly described.

### BRIEF DESCRIPTION OF THE DRAWINGS

In the drawings, wherein the same reference number indicates the same element throughout the several views:

FIG. 1 is a perspective view of an extension container, according to one embodiment.

FIG. 2 is a perspective view of an extension container attached to a main shipping container, according to one embodiment.

FIG. 3 is a partial perspective view of a locking mechanism, in an unlocked position, for securing an extension container to a main shipping container, according to one embodiment.

FIG. 4 is a partial perspective view of the locking mechanism, shown in FIG. 3, in an engaged or locked position.

FIG. 5 is a partial side-sectional view of the locking mechanism shown in FIGS. 3 and 4.

FIG. 6 is a perspective view of four extension containers stacked on top of one another and secured to a transportation pallet, according to one embodiment.

FIG. 7 is a perspective view of the four extension containers, shown in FIG. 6, separated from one another and from the transportation pallet.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below. However, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

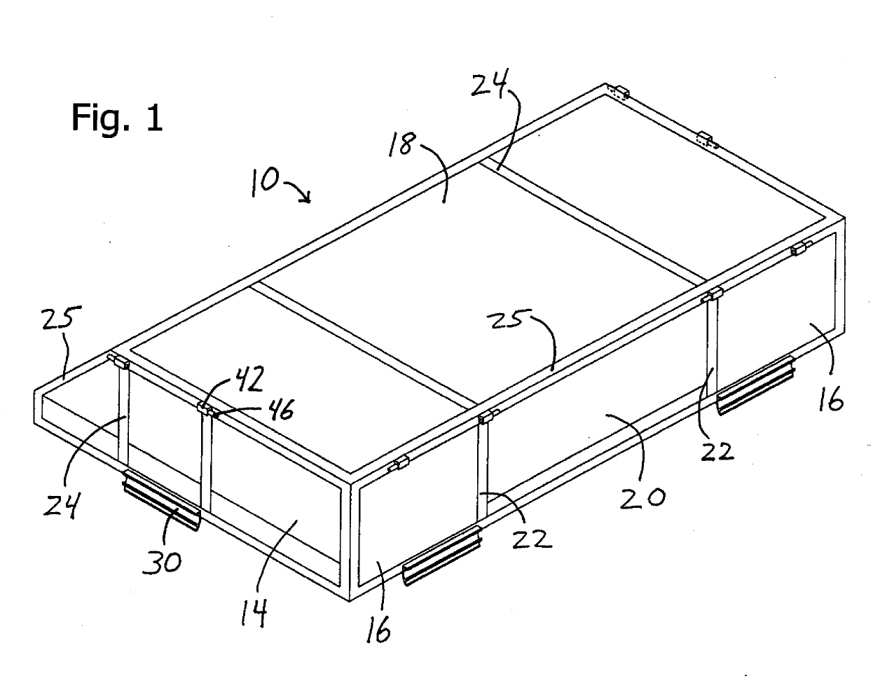

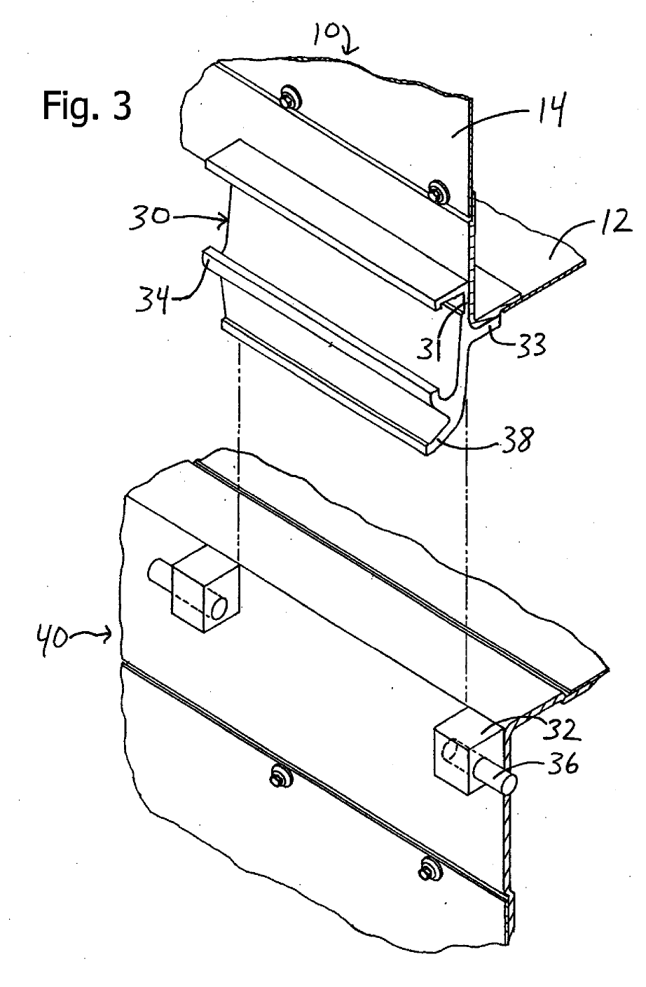

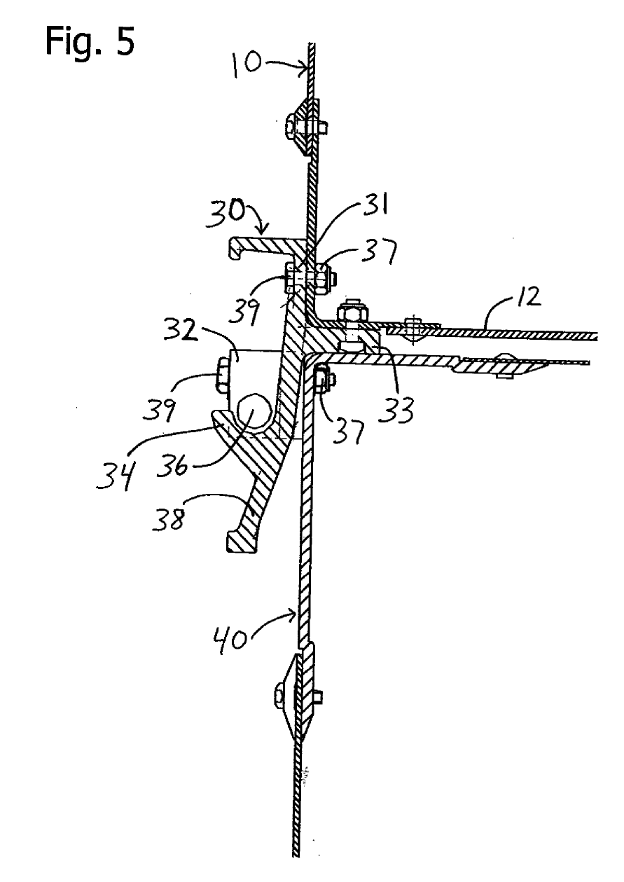

FIG. 1 illustrates an extension unit, or an extension container 10, for an air cargo container, according to one embodiment. The extension container 10 may include a base 12 (shown in FIGS. 3-5), side panels 14, front panels 16, rear panels (not visible in the drawings), and top panels 18 supported by frames 25. The various panels in conjunction with the support frames 25 form walls of the extension container 10. The extension container 10 optionally includes one or more cross members or other support members 24 for providing additional structural support to the extension container 10. The rear wall may optionally be sloped or chamfered so that it substantially conforms to the interior of a typical aircraft fuselage.

A door 20 through which cargo items may be loaded and unloaded is typically located between the front panels 16 although the door may be placed in, or itself form, any surface or side of the extension container 10. The extension container may alternatively have a clam shell type design. A panel or side may be entirely removable, or it can be hinged, to provide a door opening. The door 20 may be a roll-up door made of a flexible fabric material, or it may be made of a plastic, metal, wood, or other suitable material. In one embodiment, the door 20 is made of a flexible fabric material and includes cables sewn into outer vertical edges of the door 20. The cables are insertable into corresponding channels in door support members 22 on either side of the door 20 for guiding the door along the door support members 22, as described in detail in U.S. patent application Ser. No. 10/655,890, filed Sep. 5, 2003, which is incorporated herein by reference. In an alternative embodiment, the front panels 16 may be omitted, and the door may occupy substantially the entire length of the extension container 10.

A “sweeping shoe” or netting may be included inside the rear section of the extension container 10 to aid an operator in removing packages from the rear section. The netting may be attached to one or more ropes or straps extending toward the front of the extension container 10. An operator can pull the ropes or straps toward the front of the extension container 10, causing the netting to drag cargo items from the rear interior section to the front of the extension container 10 for easier unloading of the items. Alternatively, a rod, broom handle, or similar device may be included or detachably secured inside the extension container 10, or may be separate from the extension container 10, for use in removing cargo items located in the rear section of the extension container 10. Although shown with substantially flat walls, the extension container 10 may also have one or more curved walls.

The various components of the extension container 10 may be constructed of aluminum, or of any other suitable materials that provide requisite structural strength and that are preferably relatively lightweight. In one embodiment, all (or substantially all) of the components of the extension container 10 are made from aluminum. In another embodiment, the top panels 18 and the base 12 of the extension container 10 are made from aluminum, while the front, side, or rear panels are made from a transparent polycarbonate material or other transparent material. The various container components are preferably riveted, welded, bolted, adhered, or otherwise suitably connected to one another to form the extension container 10.

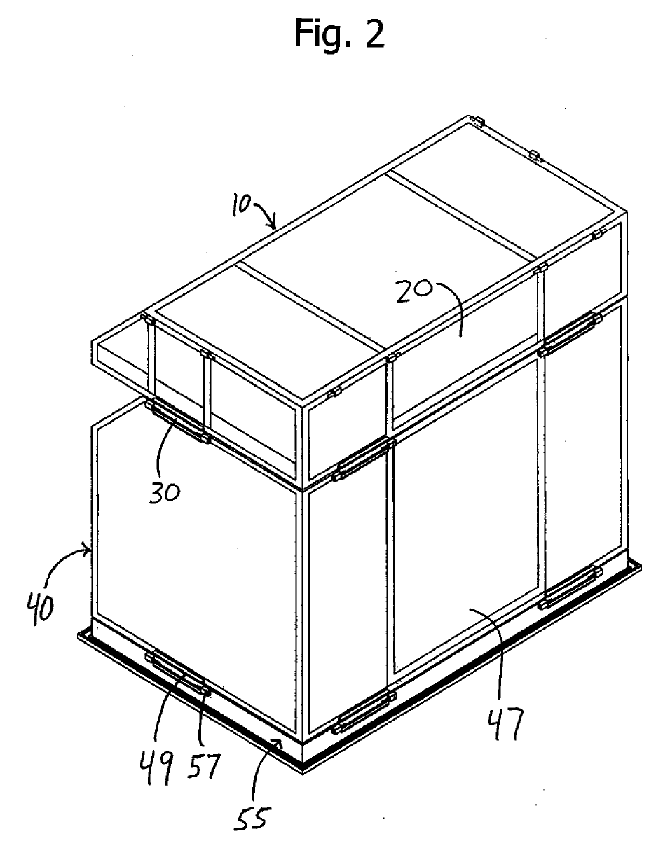

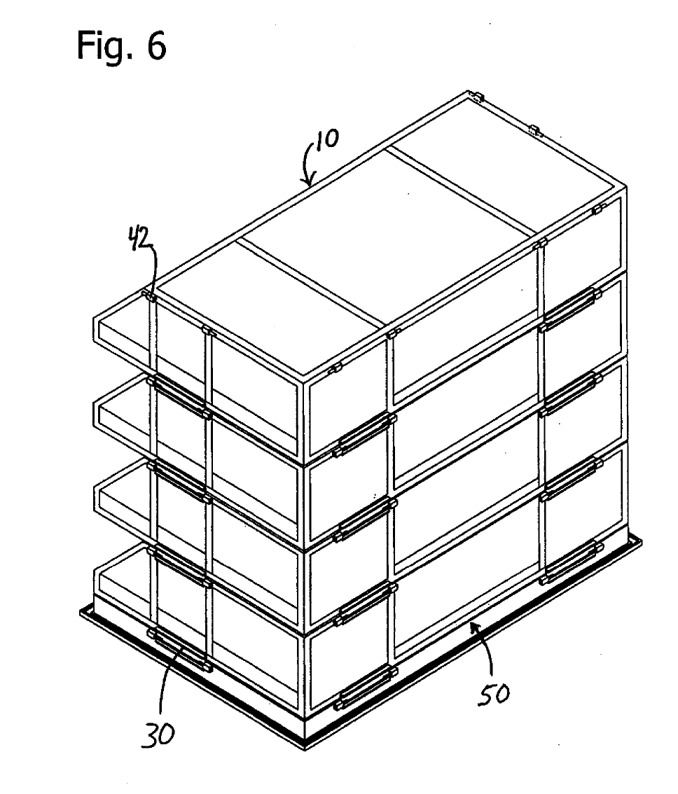

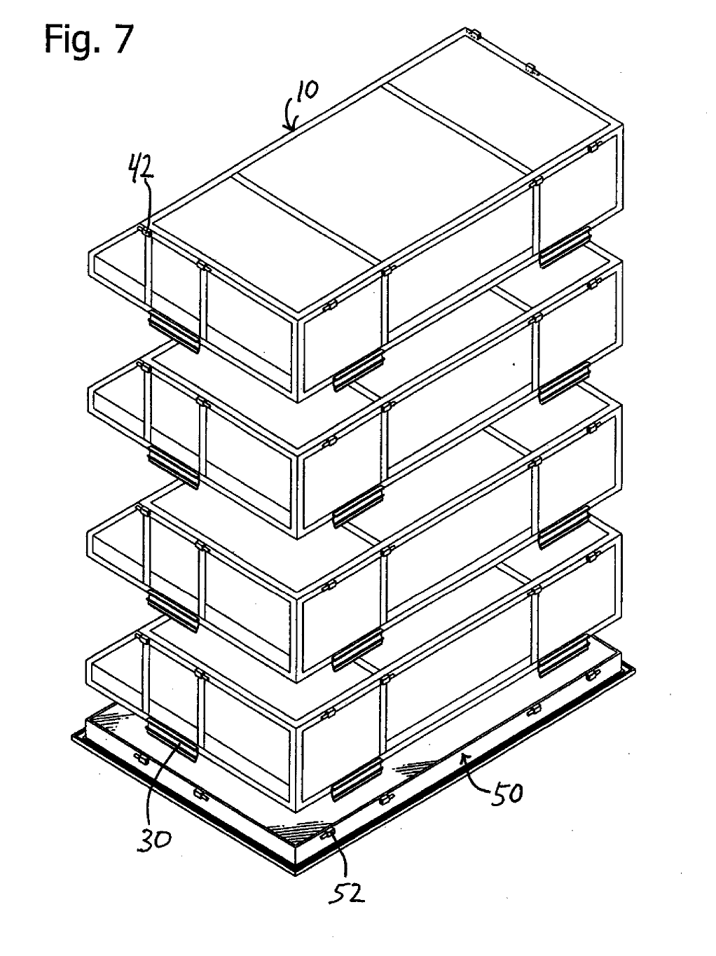

Referring to FIGS. 2-5, the extension container 10 is attachable to a main container, which may be a standard shipping container. Various elements may be equivalently used for attachment. These include flanges, pins, clamps, slots, fittings, straps, threaded fasteners, levers, etc., all collectively referred to here as attachment devices. The specific attachment device(s) used is not essential. In the example shown in the drawings, a lower portion of the extension container 10 includes one or more downwardly extending flanges 30, or other engagement elements or members. The flanges 30 may be made of a metal, such as steel or aluminum, or of one or more other suitable materials. The flanges 30 are configured to engage or mate with receiving elements 32, or other receiving mechanisms, attached to an upper portion of a standard shipping container 40, or to receiving elements 52 attached to an upper portion of a transportation pallet 50 (as shown in FIGS. 6 and 7), or to another suitable structure. Suitable standard shipping containers to which receiving elements 32 (or other components described herein) may be added are described in U.S. patent application Ser. No. 10/655,890.

The shipping container 40 includes a door 47 through which cargo items may be loaded and unloaded. The door 47 may optionally have substantially the same width as, and be substantially aligned with, the door 20 on the extension container 10, as shown in FIG. 2. The lower portion of the shipping container 40 optionally includes one or more flanges 49 (or other engagement elements or members), which may be similar to or the same as the flanges 30 on the extension container. The flanges 49 are configured to engage or mate with receiving elements 57, or other receiving mechanisms, attached to an upper portion of a support pallet 55, or to other suitable structure. The shipping container 40 may therefore be a standard M1 shipping container, or similar container, modified to include receiving elements 32 or flanges 49 (or other engagement elements), or it may be an originally-manufactured container.

The flanges 30 and receiving elements 32, which together form a locking mechanism, may be attached to the frame members 25 (or other structural members or support members) of the extension container 10 and of the standard shipping container 40 (or other structure), respectively, with nuts 37 and bolts 39, screws, rivets, or any other suitable attachment elements. In one embodiment, as is best shown in FIGS. 3-5, the flanges 30 include an upwardly extending arm 31 and an inwardly extending arm 33 attached to the side (or front or rear) and bottom, respectively, of the extension container 10. The flanges 30 may alternatively be attached to the extension container 10 in any other suitable manner.

In one embodiment, the flanges 30 include a downward protrusion or guide member 38 that is curved or angled outwardly away from the extension container 10 to aid in guiding the flange 30 over the top of the shipping container 40 or other structure. The flanges 30 may optionally be tapered or narrowed in a downward direction (i.e., from top to bottom) so that they may be readily guided between the receiving elements 32. Additional alignment elements, such as alignment pins that pass through openings or slots in outwardly-extending members on the extension container 10 and the shipping container 40, may optionally be included to further aid in aligning the extension container 10 with the shipping container 40.

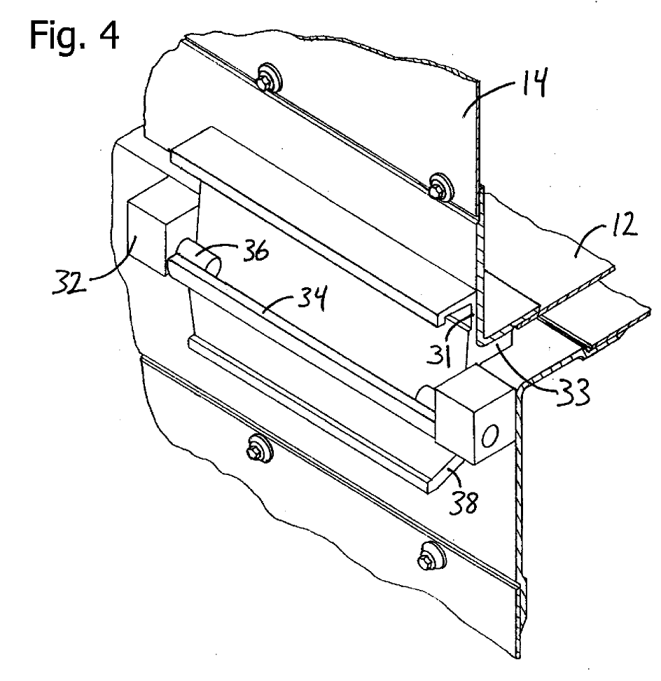

Each flange 30 preferably includes an upwardly curved, or substantially U-shaped, protrusion 34 for engagement with plungers 36, or similar elements or members, located on or in the receiving elements 32. In one embodiment, each receiving element 32 provides a housing for a substantially cylindrical plunger 36 that is manually or automatically (via a motor, spring mechanism, etc.) moveable between an open position, as shown in FIG. 3, and an engaged or locked position, as shown in FIG. 4. The receiving elements 32 and the plungers may be made of a metal, such as steel or aluminum, or of a wood, or of one or more other suitable materials.

After an extension container 10 is lowered onto a standard shipping container 40 or other structure, such that each flange 30 is positioned between two corresponding receiving elements 32, the plungers 36 may be manually or automatically moved inwardly, from the position shown in FIG. 3 to the position shown in FIG. 4, to secure or lock the extension container 10 to the standard shipping container 40 (or other structure). The plungers 36 may be moved in the opposite outward direction to free the extension container 10 from the shipping container 40.

Flanges 30 (or other engagement elements or members) are preferably attached to lower portions of the front wall and side walls of the extension container 10. As shown in FIGS. 1, 2, 6, and 7, each extension container 10 may include two flanges 30 on the front wall, and one flange 30 on each side wall, of the extension container 10. In this configuration, the combined container assembly meets safety standards for flight, assuming approved materials are used to construct the combined container assembly.

In an alternative embodiment, the rear portion of the extension container 10 may be configured to mate with an upper portion of a shipping container 40 or other structure, and may therefore additionally or alternatively include one or more flanges 30 (or other engagement elements or members), attached thereto. Any suitable number of flanges 30 (or other engagement elements or members) may be included at any suitable locations on the extension container 10.

In another alternative embodiment, the engagement members or flanges 30 are attached to the upper portion of the main shipping container 40 (or other structure), and the receiving elements 32 or other receiving mechanisms are attached to the lower portion of the extension container 10. It is also contemplated that one or more engagement members or flanges 30 may be located on both the lower portion of the extension container 10 and on the upper portion of the shipping container 40 (or other structure), and that corresponding receiving mechanisms or receiving elements 32 may be located on the other respective container or structure.

The extension container 10 may have any dimensions suitable for a given application. In one embodiment, the extension container 10 is configured for mating with a standard M1 shipping container. In this embodiment, the base 12 of the extension container 10 is preferably rectangular, with a length ranging from 100 to 150 inches, or 120 to 130 inches, and a width ranging from 75 to 110 inches, or 90 to 100 inches. The base of a standard M1 shipping container has a length of approximately 125 inches and a width of approximately 96 inches. Thus, the base 12 of an extension container 10 configured for mating with such a shipping container preferably has similar dimensions.

The front panels 16 and side panels 14 of the extension container 10 may have a height of 15 to 30 inches, or 20 to 25 inches, or may have any other dimensions suitable for a given application. When configured to mate with a standard M1 shipping container, which has a height of approximately 96 inches, the front panels 16 and side panels 14 preferably have a height of approximately 22 to 24 inches so that the combined container assembly may occupy substantially all of the available vertical space in a Boeing 747 cargo aircraft, which typically accommodates up to 120 vertical inches of cargo.

When sloped or chamfered, the rear wall of the extension container may be at an angle of approximately 35 to 45°, or approximately 39°, or any other suitable angle, relative to the base 12 of the extension container 10. By including the sloped rear wall, the extension container 10 can substantially conform to a typical aircraft fuselage, thus maximizing the amount of available space that the extension container 10 can occupy in the aircraft. In an alternative embodiment, the rear wall of the extension container 10 is not sloped, such that the extension container 10 has rectangular side walls. Such an embodiment may be preferable for an extension container intended to be loaded into a central region of a large aircraft, where the extension container does not have to accommodate the curved interior of the aircraft fuselage, or for other “non-curved” applications.

A standard M1 shipping container typically provides 593 cubic feet of available storage space. An extension container 10 with the dimensions described above provides approximately 120 to 145 cubic feet of available storage space, depending on the precise dimensions selected and whether the rear wall of the extension container 10 is sloped. Thus, by adding an extension container 10 to a standard M1 shipping container, approximately 20 to 25% more cargo can be stored at a given container location within an aircraft. Even at the higher end of this range (i.e., at approximately 735 cubic feet of available storage space in the combined container assembly), an average cargo load would be approximately 11,000 pounds, well under the certified container load capacity of 15,000 pounds.

A typical Boeing 747 cargo aircraft has the capacity to house 29 standard M1 containers, six of which are limited by fuselage ceiling limitations to a height of approximately 96 inches. The remaining 23 M1 containers may be as tall as approximately 120 inches. Thus, extension containers 10 may be added to 23 of the standard M1 containers in a given aircraft, providing an increase of approximately 16 to 20% of available storage space utilized in the aircraft.

Referring to FIGS. 1, 6, and 7, the extension container 10 preferably includes receiving elements 42 or mechanisms, attached to upper portions of the support frames 25 or other structural members, that may be the same or similar to the receiving elements 32 on the standard shipping container 40. The receiving elements 42 include plungers 46, or similar elements or members, located on or in the receiving elements 42, for engagement with flanges 30 on other extension containers. Accordingly, any suitable number of extension containers 10 may be stacked on top of, and secured to, one another as shown in FIG. 6.

As is best shown in FIG. 7, the bottom-most extension container 10 in a stack may be secured to a transportation pallet 50 to form a transportation assembly. The transportation pallet 50 is preferably dimensioned to substantially correspond to the base dimensions of the extension container 10, and may be made of aluminum, wood, or any other suitable materials. The transportation pallet 50 includes receiving elements 52 or receiving mechanisms, attached to upper-side portions of the pallet 50, that may be the same or similar to the receiving elements 32 on the shipping container 40. Accordingly, the flanges 30 or engagement elements on the bottom-most extension container 10 may engage the receiving elements 52 on the transportation pallet 50 to secure the extension container 10 to the pallet 50.

The stack of extension containers 10 may be loaded for transport onto a truck, aircraft, or other vehicle via a forklift or other lifting mechanism or device. The pallet 50 optionally includes front, rear, or side openings to accommodate the tines of a forklift. Once loaded, the stack of extension containers 10 may be transported to a desired destination. For example, the stack of extension containers 10 may be transported by truck to an airport to which standard shipping containers 40 have been or will be delivered, either in the same truck or in a different truck or trucks. At the airport, each extension container 10 may be lifted off of the stack and lowered, via a forklift or other lifting mechanism or device, onto the top surface of a respective shipping container 40. The plungers 36 in the receiving elements 32 of the standard shipping container 40 may then be manually or automatically moved into engagement with the flanges 30 on the extension container 10 to secure the extension container 10 to the shipping container 40. The combined container assembly may then be loaded onto an aircraft, via a forklift or other lifting mechanism or device.

Because the extension containers 10 are relatively small, they are more likely to be customer-specific than are the larger standard shipping containers 40, which are more likely to be used to transport cargo for multiple customers. Furthermore, because the extension containers 10 may be transported separately from the standard shipping containers 40, customers or freight forwarders have the option to carefully load their cargo items into the extension containers 10 before they are shipped to an airport. Thus, the extension containers 10 can be ready for mating with a shipping container 40 upon arrival at the airport. Similarly, in some cases, extension containers 10 containing a customers cargo may be shipped directly to the customer. In these instances, airline carriers are freed from having to load and unload the extension containers 10, which can be a labor intensive and time-consuming process.

While several embodiments have been shown and described, various changes and substitutions may of course be made, without departing from the spirit and scope of the invention. The precise dimensions of any feature described, for example, are not material to the invention, unless specifically recited in the claims. The invention, therefore, should not be limited, except by any claims and their equivalents.

What is claimed is:

1. An extension container for attachment to an air cargo shipping container, comprising:
a front wall;
a rear wall;
a plurality of side walls connected to the front and rear walls;
a downwardly extending engagement element attached to a lower portion of at least one of the front wall, the rear wall, and one of the side walls, with the engagement element including a protrusion for engagement with a receiving mechanism on a shipping container.

2. The extension container of claim 1 wherein the protrusion is upwardly curved.

3. The extension container of claim 1 wherein the engagement element includes a guide member located below the protrusion, with the guide member angled outwardly away from the extension container for guiding the extension container over top of a shipping container.

4. The extension container of claim 1 further comprising at least one receiving element, for mating with an engagement element on a separate extension container, attached to an upper portion of at least one of the front wall, the rear wall, and one of the side walls.

5. The extension container of claim 1 further comprising a door in the front wall through which cargo items may be loaded and unloaded.

6. The extension container of claim 5 wherein the door comprises a roll-up door made of a flexible fabric material.

7. The extension container of claim 5 wherein the rear wall is sloped.

8. The extension container of claim 5 further comprising a netting in a rear interior section of the container, with a plurality of ropes or straps attached to the netting to facilitate an operator pulling the netting toward the front of the container to drag cargo items from the rear interior section to the front of the container.

9. An air cargo container assembly, comprising:
a first container including an engagement element having a curved region; and
a second container detachably connected to the first container via a receiving mechanism that mates with the engagement element on the first container, wherein the receiving mechanism includes at least one plunger that is moveable between:
an open position that facilitates detaching the first container from the second container; and
a locked position in which the plunger engages the curved region of the engagement element on the first container to secure the first container to the second container.

10. The air cargo container assembly of claim 9 wherein the engagement element comprises a flange including a guide member angled outwardly from the first container.

11. The air cargo container assembly of claim 9 wherein the receiving mechanism comprises two housings, each including one plunger, located on opposite sides of the engagement element, with the plungers moveable toward each other into a position in which a portion of each of the plungers engages the curved region of the engagement element.

12. The air cargo container assembly of claim 9 wherein one of the first and second containers is a main container, and the other of the first and second containers is an extension container.

13. The air cargo container assembly of claim 12 wherein a height of the extension container comprises between 15 and 25% of a total height of the air cargo container assembly.

14. The air cargo container assembly of claim 9 wherein the first container includes at least two engagement elements on a front wall thereof and at least one engagement element on each side wall thereof.

15. The air cargo container assembly of claim 14 wherein a front wall of each of the first and second containers includes a door through which cargo items may be loaded and unloaded.

16. An air cargo container system, comprising:
a main container having a height H, a width W, and a length L;
an extension container having a height less than H, a width substantially equal to W, and a length substantially equal to L; and
one or more attachment elements for holding the extension container onto a top surface of the main container.

17. The air cargo container system of claim 16 further comprising a pallet, with the extension container alternately removably attachable, via at least one locking mechanism, to the main container unit to form an air cargo container assembly, and to the pallet to form a transportation assembly.

18. The air cargo container system of claim 17 wherein the extension container includes at least one engagement element that is alternately engageable with at least one receiving mechanism on the main container and at least one receiving mechanism on the transportation pallet.

19. The air cargo container system of claim 18 wherein the engagement element comprises a downwardly extending flange including an upwardly curved protrusion, and wherein each of the receiving mechanisms includes at least one moveable plunger for engaging the upwardly curved protrusion.

20. An air cargo container assembly, comprising:
a first air cargo container;
a second air cargo container; and
means for attaching the second air cargo container to a top surface of the first air cargo container.
